(19) United States
(12) Patent Application Publication
(10) Pub. No.: US 2017/0139500 A1
(43) Pub. Date: May 18, 2017

(54) TOUCH SCREEN PANEL WITH SURFACE HAVING ROUGH FEEL

(71) Applicant: Microsoft Technology Licensing, LLC, Redmond, WA (US)

(72) Inventors: Timothy A. Large, Bellevue, WA (US); James D. Holbery, Bellevue, WA (US); Robert McPherson, Seattle, WA (US)

(73) Assignee: MICROSOFT TECHNOLOGY LICENSING, LLC, Redmond, WA (US)

(21) Appl. No.: 14/942,760

(22) Filed: Nov. 16, 2015

(51) Int. Cl. G06F 3/044

(52) U.S. Cl. CPC G06F 3/044

(57) ABSTRACT

A touch screen panel comprises an outer surface that defines a touch sensitive surface with a touch sensitive area. The outer surface comprises friction features distributed throughout at least a portion of the touch sensitive area according to one or more predetermined spacings. The friction features are configured to have predetermined friction characteristics that impart a desired tactile effect, e.g., a paper-like feel, to the touch sensitive surface when contacted by a user's finger or a stylus. Methods of forming a touch screen panel with predetermined friction features are also described.

### BACKGROUND

Touch screen panels are increasingly important in today's market place as users demand the intuitive capabilities of using a finger, or in some cases a stylus, to interact and provide input. Touch screen panels are used on a wide array of computing devices, including mobile devices, notebook, laptop and desktop computers, and increasingly, in specialized display applications as well.

Improving the user experience in interacting with touch screen panels has proven to be a continuing challenge. Users have a tactile sense of touch that can dramatically improve their visual experience when touch is stimulated thoughtfully.

### SUMMARY

Described below are implementations of a touch screen panel that improves a user's visual experience by stimulating the user's tactile sense of touch.

According to one implementation, a touch screen panel comprises an outer surface defining a touch sensitive surface with a touch sensitive area, and the outer surface comprises friction features distributed throughout at least a portion of the touch sensitive area according to one or more predetermined spacings. The friction features are configured to have predetermined friction characteristics that impart a desired tactile effect to the touch sensitive surface when contacted by a user's finger or a stylus. One exemplary desired tactile effect is a paper-like feel.

The outer surface can comprise a layer applied to a substrate, and the layer can comprise at least two different materials interspersed with each other to define the friction features and develop the predetermined friction characteristics. The material applied to the substrate can be planarized to make the outer surface substantially planar. The two materials can be selected to have respective indices of refraction that closely match each other (in some implementations, these indices of refraction for the two materials also match an index of refraction for the substrate). At least one of the predetermined spacings for the friction features can be in a range between 10 microns and 200 microns.

According to another implementation, a touch screen panel comprises an outer surface defining a touch sensitive surface with a touch sensitive area, wherein the outer surface comprises at least first areas having predefined first surface energies and second areas having predefined second surface energies different from the first surface energies, wherein the first areas and the second areas are interspersed with each other throughout at least a portion of the touch sensitive area according to one or more predetermined spacings, and wherein differences in first and second surface energies cause a user's finger or stylus to slip and stick when moved between one of the first areas and an adjacent one of the second areas.

In some implementations, the outer surface comprises a layer applied to a substrate, and the layer comprises at least two different materials interspersed with each other to define the respective first areas and second areas. In other implementations, the layer applied to the outer surface is a monomolecular or other polymer layer. The monomolecular or polymer layer can be plasma etched to define areas having the first and second surface energies and maintaining a predetermined resolution of the display.

According to a representative method of forming a touch screen panel, the method comprises forming an outer surface of the touch screen panel to define a touch sensitive area having friction features distributed throughout at least a portion of the area and configured to impart a paper-like feel when contacted by a user's finger or stylus.

Forming an outer surface of the touch screen panel can comprise adding a layer of material to a substrate to define the outer surface. Forming an outer surface of the touch screen panel can comprises applying at least one layer to a substrate, and the layer can comprise at least two different materials interspersed with each other to define the friction features that develop predetermined friction characteristics to impart the paper-like feel. The materials added to the substrate can be selected to have respective indices of refraction closely matching an index of refraction of the substrate. The method can further include planarizing the at least one layer added to the substrate to make the outer surface of the touch screen substantially planar.

In an alternative method implementation, forming an outer surface of the touch screen comprises depositing a first material on a substrate in a substantially uniform layer, patterning the first material to define spaced-apart first areas of the first material, curing the first layer, depositing a second material in spaced-apart second areas defined between adjacent first areas, and curing the second material, the friction features in the outer surface of the touch screen comprising intersections between the first areas and the second areas. At least one of the first material or the second material comprises a resin doped with nano-particulates.

### BRIEF DESCRIPTION OF THE DRAWINGS

FIG. 1A is a schematic side elevation view of a conventional touch screen panel in which a cover lens component of the panel defines the touch sensitive surface that is contacted by a user's finger and/or a stylus.

FIG. 1B is a schematic side elevation view of a new touch screen panel in which at least a portion of the touch sensitive surface is defined by material added to the cover lens.

FIG. 2 is a combined schematic process diagrams showing steps of a representative process used to produce the new touch screen panels and side views of their components.

FIGS. 3-6 are schematic side elevation views of several conventional touch screen technologies with which the new touch screen panel can be implemented.

FIG. 7 is a false color height map of a sample of paper that is highly magnified to show the three-dimensional structure of its surface.

FIG. 8 is a graph of the coefficient of friction for a stylus as it moves across a sample of paper.

FIG. 9 is a binarized depth map developed based on the sample of paper of FIG. 7.

FIG. 10 is a schematic drawing showing a sampling of computing and other touch screen devices with which the new touch screen panel can be used.

### DETAILED DESCRIPTION

Described below are implementations of a new touch screen panel having a touch sensitive surface with friction features distributed throughout at least a portion of the surface area and configured to have friction characteristics that impart a comparatively rough feel, such as a paper-like feel, when a user contacts the surface with a digit (such as a finger or a stylus). More generally, the new touch screen panel is configured to generate a predetermined tactile response. Touch screen panels can be implemented for any application requiring display of information and receiving input from a user, and are common for mobile devices (such as mobile phones and tablets), notebook and laptop computers and many other kinds of computing devices.

As described below, the new touch screen panel can be implemented using any suitable touch panel technology, including transparent touch technologies such as capacitance touch and projected capacitance touch (including in-cell, sensor on lens, on-cell and other variations), and even some forms of resistive touch technologies. The new touch screen panel can also be implemented for e-ink applications. The underlying display can be of any type, including LCD, OLED, LED, eInk, etc. Other techniques, including pressure sensing technology and surface acoustic wave technology, can also be used. As indicated, the new touch panel can be touch sensitive to a digit of any type, including a finger, a non-active stylus, an active stylus, or other similar device.

Touch screen panels are comprised of multiple layers, called a “stack,” that are in contact with or closely spaced from each other. In a conventional touch screen panel using capacitance touch, projected capacitance touch or some other touch technologies, the outermost surface in which or on which the touch sensitive surface is formed is typically made of a glass, plastic (including polycarbonates, PET, acrylic, etc.) or other similar material. The component having this outermost glass, plastic or other similar material is known as a “cover lens” (sometimes referred to as a “top glass” or “top cover”), and typically has a sheet-like construction. For a cover lens made of glass, such as an ion-strengthened glass, the thickness may range from about 0.3 mm to about 0.6 mm for a smart phone application, and 0.3 mm to 1.0 mm for large displays. For a cover lens made of acrylic material, such as polymethyl methacrylate, the thickness may range from about 1.0 mm and up for a smart phone application.

In a conventional touch screen panel, the cover lens is provided to protect the underlying components from impact and the environment, and to provide an exceptionally smooth surface for executing touch operations and gestures. In addition, and as further described below, a touch screen panel with a gloss surface (in contrast to a matte surface) permits the user to easily reorient the panel for convenient viewing of the displayed content, whereas a matte or other sort of textured surface causes a reflection that reduces contrast.

In some applications, however, users appreciate a different feel than is provided by the smooth cover lens. Some touch screen technologies, called haptic technologies, employ additional active electronic components that use energy of one or more forms, e.g., to impart a feel of touch to the user by using forces, vibrations or motions. Such haptic technologies, however, are expensive to develop, require more processing power and can add to the overall thickness of the stack, which are disadvantages.

Users of touch screen panels without such haptic technologies still seek out having the tactile experience of touching paper, either with their fingers or a pen tip. Paper has a roughness typically in the range of 1μ to 5μ roughness average (RA) created by the paper's fiber content, where the fiber diameter is 10-50μ and the fiber spacing 10-200μ. A touch sensitive area simply modified to have the same roughness as paper, effectively modifying the glossy conventional cover lens surface to be a matte surface, however, introduces problems alluded to above, such as, e.g., a diffused front surface reflection that cannot reproduce full greyscale contrast or the full resolution. The surface perturbations (e.g., peaks and valleys) would create microscopic “lenslets” that tend to distort displayed images and create, among other problems, color sparkle. Glossy surfaces are generally preferred for touch screen panels, particularly for mobile device applications, because mobile devices can usually be maneuvered to eliminate viewing difficulties, even though a matte surface might provide a more desired feel. A conventional example of a matte surface that causes loss of resolution arises when a conventional surface protector or film is applied to an outer surface of a glossy cover lens.

It has been discovered that a touch sensitive surface can be patterned using length scales of about 50 to about 100 microns, and provided with areas having different surface energies, thereby imparting a paper-like feel to a user touching the surface without sacrificing display performance. In some implementations, subsequent steps are taken to maintain the touch sensitive surface in a substantially planar configuration. In either case, the modified touch sensitive surface causes a moving finger or a stylus to “slip” and “stick” as it is slid across the surface.

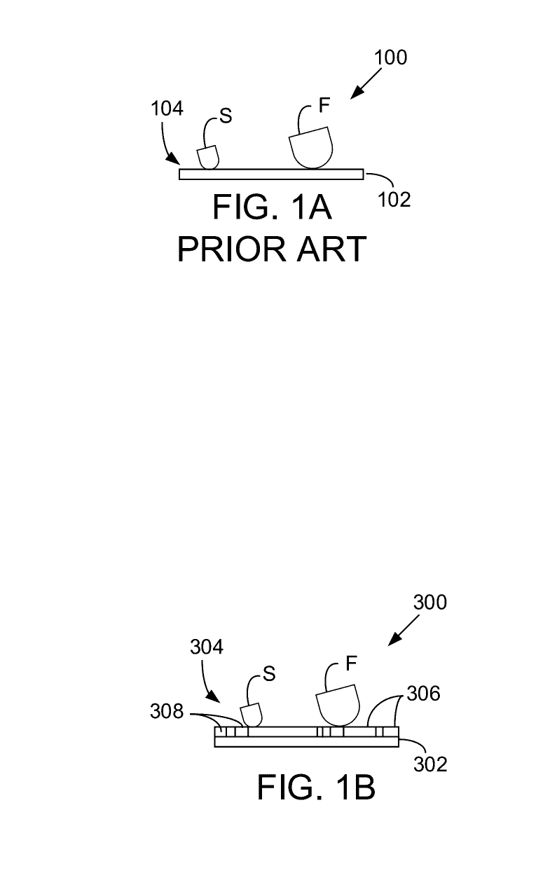

FIG. 1A is a schematic side elevation of a portion of a conventional touch screen panel 100 showing a user's finger F and a stylus S in contact with a touch sensitive surface 104, which is defined by an outer surface of a cover lens 102.

FIG. 1B is a schematic side elevation view of a new touch screen panel 300 having a touch sensitive surface 304 with friction features formed by one or more added materials coupled to the cover lens 302. Therefore, the one or more added materials define the touch surface 304 in the illustrated portion of the touch screen panel 300. As illustrated schematically, friction areas occur at changes in the surface, and these can be positioned throughout one or more desired areas of the touch sensitive surface according to a predetermined pattern to cause the display to have a paper-like feel to the user. The changes in the surface can occur, e.g., at intersections of different materials and/or areas of different surface energies.

It should be noted that the dimensions of the layers and the friction features are not shown to scale but instead have been exaggerated for purposes of illustration. In the example of FIG. 1B, the touch sensitive surface's entire area is modified, but in practice only one or more portions of the entire area may be modified. The friction features in the illustrated implementations are formed at any suitable spacing for the desired tactile effect, such as from 10 microns to 200 microns according to some examples.

In the specific example of FIG. 1B, the touch sensitive surface 304 has friction features distributed throughout that are formed at the junctions of a first added material 306 and a second added material 308, which are both coupled to the cover lens 302. As can be seen, the touch sensitive surface 304 has a substantially planar configuration. The first added material 306 can be a resin. The second added material 308 can be another suitable material having a surface energy different from the first added material. For example, the second added material can be a Teflon or a high-refractive index silicone resin material. The first added material 306 and the second added material 308 are each selected to have an index of refraction that matches an index of refraction of the cover lens 302. In this way, optical and visual effects arising because of the boundary between two different materials are greatly reduced. That is, the materials 306 and 308 are selected such that the optical performance of the touch screen panel is not significantly degraded, and such that the materials 306, 308 form friction areas at their intersections to give the desired feel.

In some implementations, one of the materials may be a coating doped with nano-particulates to yield desired properties, such as hardness, surface energy and/or index of refraction. In one example, a base polymer may be doped with nano-particles of an inorganic material. For example, display and optical components that can increase the optical performance of polymers and monomers (including increasing the refractive index) may be used.

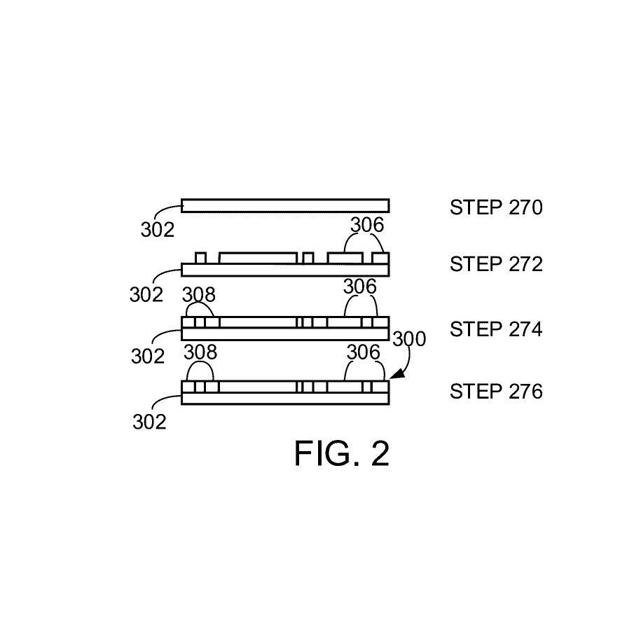

FIG. 2 is a schematic process diagram showing steps of a representative method used to develop the touch sensitive surface 306 of FIG. 1B. The process begins with a substrate (step 270), which in the illustrated implementation is the cover lens 302. In subsequent steps, the added material or materials are coupled to the cover lens 302 at predefined locations. For example, the added materials may be deposited on the cover lens 302 in a printing, photolithography or other similar process.

In step 272, the first added material 306 is applied to the cover lens 302 in a predetermined pattern. In one implementation, the first added material 306 is printed, then dried for about three minutes at 90 degrees C., and then cured for 90 minutes at 140 degrees C. In this way, the first added material 206 is appropriately bonded to the cover lens 302.

In step 274, the second added material 308 is applied in a predetermined pattern, followed by similar drying and curing operations. As can be seen, the predetermined pattern of the second added material 308 can include “filling in” gaps separating areas of the first added material 306. In step 276, the resulting surface is subjected to a planarization operation, such as with a roller, so that the touch sensitive surface 304 of the finished touch screen panel 300 is substantially planar.

It is also possible to pattern the cover lens, such as by using plasma etching, to have a very thin layer, for example, a mono-molecular layer of a suitable pattern to impart the desired tactile effect. Such an effect may wear away as the patterning is worn, but offers an alternative approach to adding material to the cover lens.

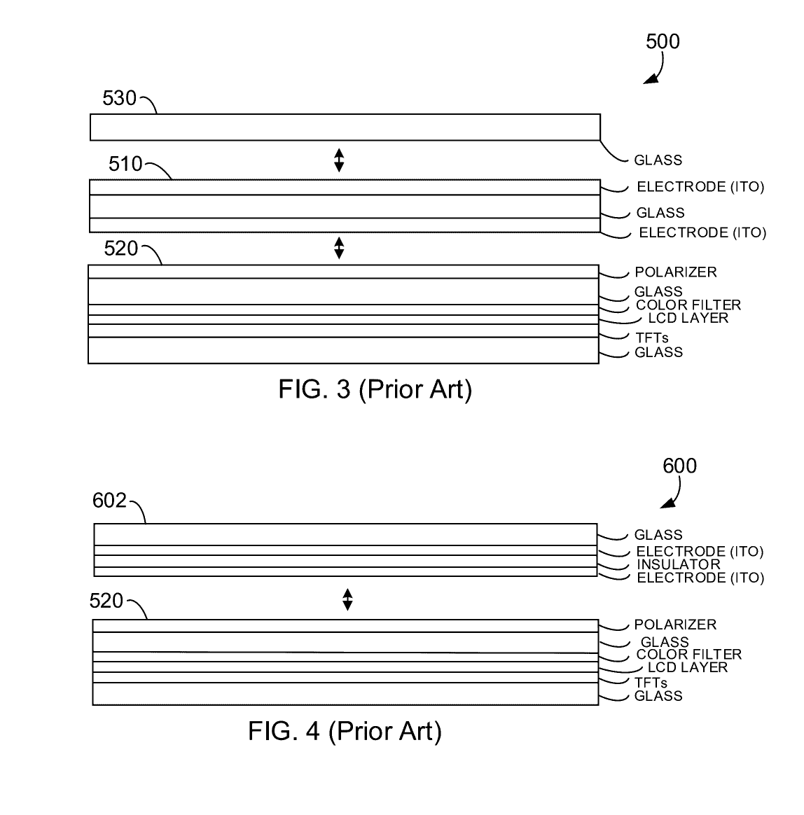

FIGS. 3-6 are schematic side elevation views of several different conventional touch screen panel technologies showing the layered constructions in slightly more detail. The various layers and other features have been drawn for purposes of illustration and are not shown to scale. It should be noted that FIGS. 3-6 are only representative and should not be considered limiting as to the types of touch screen panel technologies to which the new techniques can be applied. Rather, the new techniques described herein can be applied to virtually any touch screen panel having a cover lens as described above.

FIG. 3 is a schematic depiction of a conventional projected capacitance touch screen 500 with a separate module. A touch module 510 is formed by coating both sides of a glass sheet with a conductor, which may be indium tin oxide (ITO), and then the coating is patterned to create electrodes. The touch module 510 is laminated to an LCD panel 520 using a suitable adhesive. Similarly, the cover lens 530 is adhered to the touch module 510 with a suitable adhesive. The cover lens 530 serves to protect the electrodes and to provide a surface with which the user can interface by touch.

FIG. 4 is a schematic depiction of a conventional projected capacitance touch screen 600 with a “one-glass solution” (OGS) in which one of the glass layers is eliminated from the conventional projected capacitance stack shown in FIG. 3. As can be seen, the electrodes are patterned on a back surface of the cover lens 602.

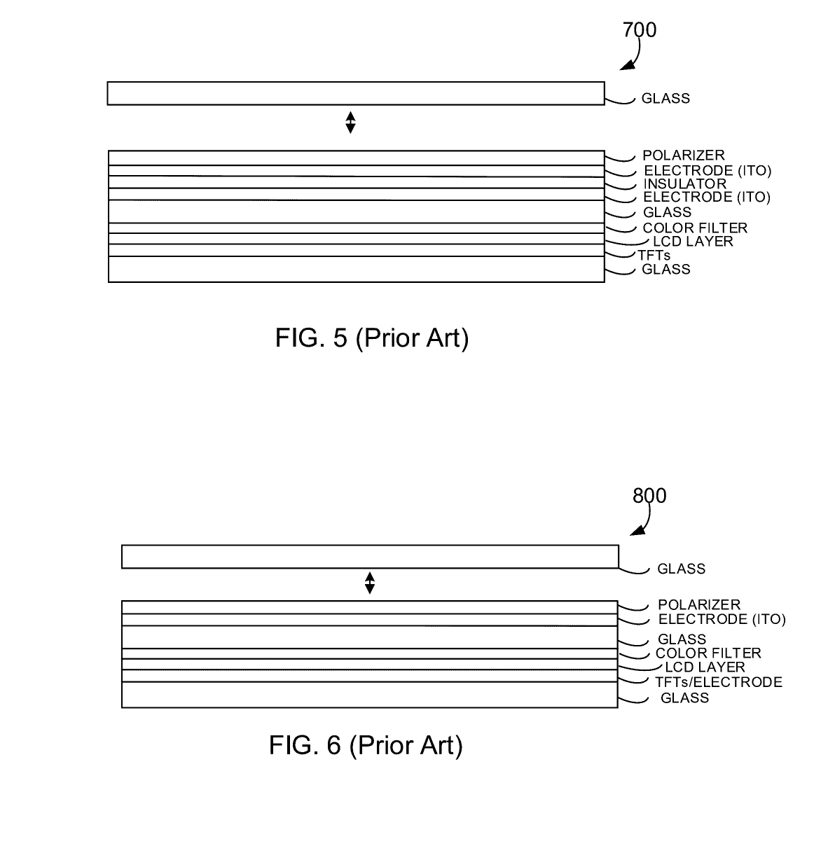

FIG. 5 is a schematic depiction of a conventional projected capacitance touch screen 700 with an “on cell” form of a one-glass solution. In this design, it is the top layer of glass in the LCD display (the “cell”) that receives a layer of indium tin oxide (ITO) and is patterned into electrodes.

FIG. 6 is a schematic depiction of a conventional projective capacitance touch screen 800 with an in-cell feature in which one of the conductive layers shares the same layer as the thin film transistors (TFTs) used to switch the display's pixels on and off.

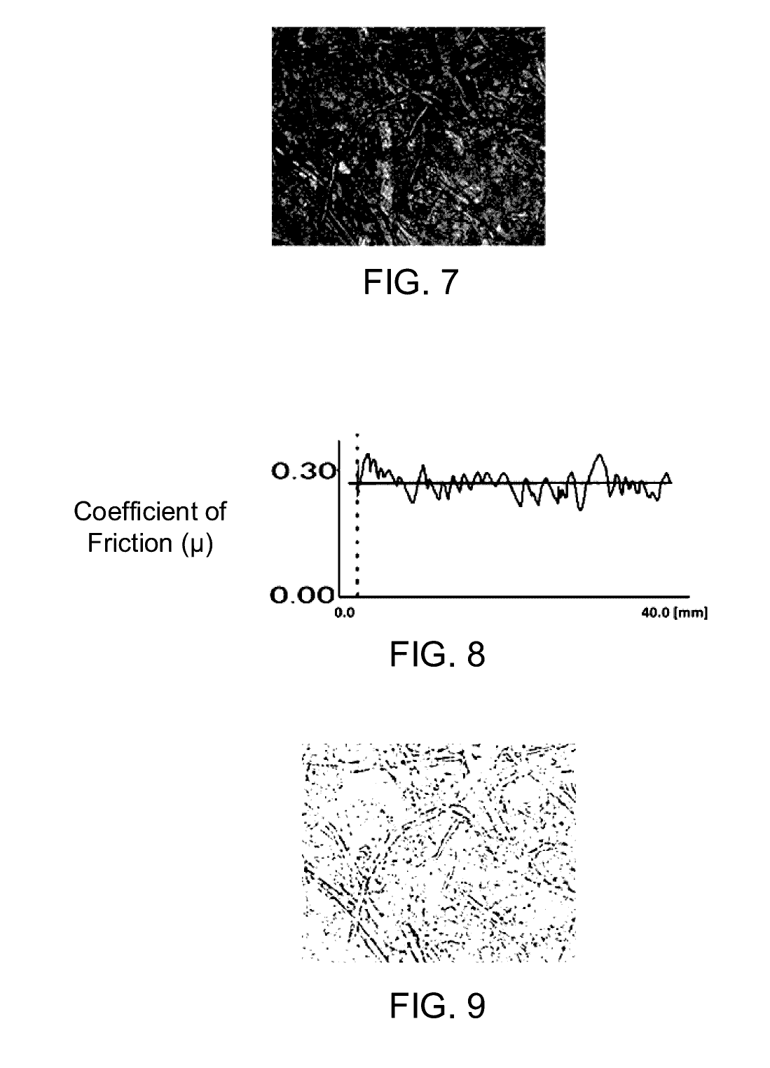

FIG. 7 is a false color height map of the surface of a sample of paper shown at high magnification. The surface has fibers with three-dimensional characteristics that give rise to the rough feel of surface. In the FIG. 7 height map, the lighter areas are higher areas and the darker areas are lower areas,

FIG. 8 is a graph of the coefficient of friction for a stylus as it moves across the sample of paper, such as over a 40 mm distance as shown. The coefficient of friction is a dimensionless value defined as the lateral drag normalized to the applied vertical force.

FIG. 9 is a binarized depth map developed of sample shown in FIG. 7, in which all values above a selected threshold are white and all values below the threshold are black. FIG. 9 thus defines a representative two-dimensional pattern that can be applied to a surface to produce a desired paper-like feel.

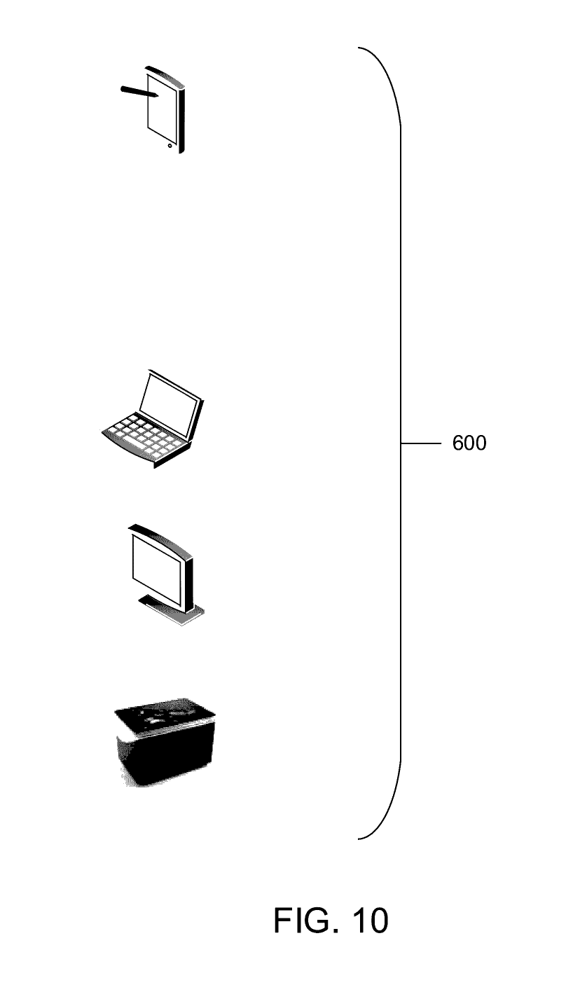

FIG. 10 is a drawing showing several representative classes of devices 600 with which the new touch screen panel can be used, including mobile devices (such as smart phones, PDAs, e-readers, watches, etc.), notebook, laptop and desktop computers, digital tables, to name a few examples.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. A touch screen panel, comprising:
an outer surface of the touch screen panel defining a touch sensitive surface with a touch sensitive area;
wherein the outer surface comprises friction features distributed throughout at least a portion of the touch sensitive area according to one or more predetermined spacings, and
wherein the friction features are configured to have predetermined friction characteristics that impart a desired tactile effect to the touch sensitive surface when contacted by a digit.

2. The touch screen panel of claim 1, wherein the desired tactile effect is a paper-like feel.

3. The touch screen panel of claim 1, wherein the outer surface comprises a layer applied to a substrate, and wherein the layer comprises at least two different materials interspersed with each other to define the friction features and develop the predetermined friction characteristics.

4. The touch screen panel of claim 3, wherein the layer applied to the substrate is planarized to make the outer surface substantially planar.

5. The touch screen panel of claim 3, wherein the two materials are selected to have respective indices of refraction that closely match each other.

6. The touch screen panel of claim 1, wherein at least one of the predetermined spacings for the friction features is in a range between 10 microns and 200 microns.

7. A touch screen panel, comprising:
an outer surface of the touch screen panel defining a touch sensitive surface with a touch sensitive area;
wherein the outer surface comprises at least first areas having predefined first surface energies and second areas having predefined second surface energies different from the first surface energies, wherein the first areas and the second areas are interspersed with each other throughout at least a portion of the touch sensitive area according to one or more predetermined spacings, and
wherein differences in first and second surface energies cause a digit to slip and stick when moved between one of the first areas and an adjacent one of the second areas.

8. The touch screen panel of claim 7, wherein the outer surface comprises a layer applied to a substrate, and wherein the layer comprises at least two different materials interspersed with each other to define the respective first areas and second areas.

9. The touch screen panel of claim 8, wherein the layer applied to the substrate is planarized to make the outer surface substantially planar.

10. The touch screen panel of claim 8, wherein the two materials are selected to have respective indices of refraction that closely match each other.

11. The touch screen panel of claim 7, wherein the outer surface comprises a monomolecular or other polymer layer that is plasma etched to define the first and second areas.

12. The touch screen panel of claim 7, wherein at least one of the predetermined spacings for the friction features is in a range between 10 microns and 200 microns.

13. A method of forming a touch screen panel, comprising:
forming an outer surface of the touch screen panel to define a touch sensitive area having friction features distributed throughout at least a portion of the area and configured to impart a paper-like feel to when contacted by a digit.

14. The method of claim 13, wherein forming an outer surface of the touch screen panel comprises adding a layer of material to a substrate to define the outer surface.

15. The method of claim 13, wherein forming an outer surface of the touch screen panel comprises applying at least one layer to a substrate, and wherein the layer comprises at least two different materials interspersed with each other to define the friction features that develop predetermined friction characteristics to impart the paper-like feel.

16. The method of claim 15, wherein the materials added to the substrate are selected to have respective indices of refraction closely matching each other.

17. The method of claim 15, further comprising planarizing the at least one layer added to the substrate to make the outer surface of the touch screen substantially planar.

18. The method of claim 13, wherein forming an outer surface of the touch screen comprises depositing a first material on a substrate in a substantially uniform layer, patterning the first material to define spaced-apart first areas of the first material, curing the first layer, depositing a second material in spaced-apart second areas defined between adjacent first areas, and curing the second material, wherein the friction features in the outer surface of the touch screen comprise intersections between the first areas and the second areas.

19. The method of claim 18, wherein at least one of the first material or the second material comprises a resin doped with nano-particulates.

20. The method of claim 18, further comprising planarizing the outer surface to make the outer surface substantially planar.
